(19) United States
(12) Patent Application Publication
(10) Pub. No.: US 2013/0132358 A1
(43) Pub. Date: May 23, 2013

(54) CONSUMER INFORMATION AGGREGATOR AND PROFILE GENERATOR

(71) Applicants: Andrey N. Nikankin, Sankt-Petersburg (RU); Rodion Shishkov, St. Petersburg (RU)

(72) Inventors: Andrey N. Nikankin, Sankt-Petersburg (RU); Rodion Shishkov, St. Petersburg (RU)

(73) Assignee: RAWLLIN INTERNATIONAL INC.

(21) Appl. No.: 13/299,877

(22) Filed: Nov. 18, 2011

(51) Int. Cl. G06F 17/30

(52) U.S. Cl. 707/706; 707/722; 707/732; 707/E17.108

(57) ABSTRACT

Disclosed are electronic systems and techniques for implementing consumer information aggregation and profile generation. An aggregator component can obtain data relating to a user from virtually any open, publicly available, or private sources of information. A profile of candidate characteristics associated with the user is generated, or updated, based on the information obtained, and the eligibility of the user for one or more offers, such as a loan, can be determined based at least in part on the profile of candidate characteristics. In this regard, banks and retailers can automate an offer decision-making process using information about the applicant that is readily available.

### TECHNICAL FIELD

The subject application relates to electronic commerce, and, more particularly, to locating publicly available information relating to the user, and using the information to generate a user profile.

### BACKGROUND

A number of consumers have experience with short term loans, payday advances, cash advances, and so forth. These types of financial instruments often require proof of employment and financial viability, such as a checking account and evidence of employment. Typically, the interest rate for such instruments can be high, due to the level of risk experienced by the lender. However, when a consumer needs to obtain a quick credit decision, there may be few alternatives except borrowing from pawn shops, friends, or family.

Additionally, consumers are frequently presented with opportunities to apply for instant approval for credit cards during internet shopping, or at the point of sale during traditional in-store shopping. Often the consumer can charge a current purchase to the new account if they are approved, and may be able to take advantage of one or more promotions for applying. However, consumers having little, or no, credit history are unlikely to be approved for these credit cards. In addition, some consumers choose not to use credit cards, or elect not to go through the application process at the time of the offer is presented.

Moreover, retailers often attempt to persuade consumers to purchase additional items, or items related to items that the consumer is purchasing. In order to tailor the suggestions to the desires of the consumer, some retailers employ loyalty cards that enable the retailer to monitor the buying patterns of the consumer. Similarly, online retailers often encourage consumers to maintain a user account with the retailer, and data tracked via the user account can be used to suggest purchase options, or tailor promotions based on the consumer's buying patterns. However, similar to instant credit card applications, some consumers choose not to go through the loyalty card application or online account setup process.

The above-described deficiencies of today's credit application and promotional tools are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for consumer information aggregation and profile generation are contained herein. An exemplary system, includes an input component configured to receive a set of identifiers associated with a user, a search component configured to generate a set of search terms based at least in part on the set of identifiers, execute a search against a set of data sources using the set of search terms, and return a set of search results, an analyzer component configured to analyze the set of search results, and at least one of generate or update a profile for the user based at least in part on a subset of the search results, and an offer component configured to determine eligibility for an offer based at least in part on the profile.

In another non-limiting embodiment, an exemplary method is provided that includes receiving a set of user information for a user, generating a set of query terms based at least in part on the set of user information, executing a search against a set of data sources using the set of query terms, returning a set of search results, determining a set of data included in the set of search results to include in a user profile, and determining an eligibility of the user for at least one offer based at least in part on the user profile.

In still another non-limiting embodiment, an exemplary computer readable storage medium is provided that includes receiving a set of user information for a user, determining a set of keywords as a function of the set of user information, executing a search against a set of data sources for the set of keywords, selecting a set of search results to include in a profile of candidate characteristics associated with the user, and determining an eligibility of the user for a loan based at least in part on the profile of candidate characteristics.

In yet another non-limiting embodiment, a exemplary system is provided that includes means for receiving a set of identifiers associated with a user, means for generating a set of keywords based at least in part on the set identifiers, means for determining a set of data sources to query based at least in part on at least one of the set of identifiers, or the set of keywords, means for executing a search against the set of data sources using the keywords, and returning a set of search results, means for ascertaining a set of characteristics associated with the user based at least in part on the set of search results, and generating a profile based on the set of characteristics, and means for analyzing the profile, categorizing the profile based at least in part on the analysis, and determining an eligibility of the user for a loan based at least in part on the categorizing.

### BRIEF DESCRIPTION OF DRAWINGS

FIG. 1 illustrates an example consumer information aggregation and profile generation system in accordance with various aspects described herein;

FIG. 2 illustrates an example consumer information aggregation and profile generation system in accordance with various aspects described herein;

FIG. 3 illustrates an example input component in accordance with various aspects described herein;

FIG. 4 illustrates an example search component in accordance with various aspects described herein;

FIG. 5 illustrates an example analyzer component in accordance with various aspects described herein;

FIG. 6 illustrates an example offer component in accordance with various aspects described herein;

FIG. 7 illustrates a block diagram of an exemplary non-limiting system that provides additional features or aspects in connection with consumer information aggregation and profile generation;

FIG. 8 illustrates an example identifier input viewing pane in accordance with various aspects described herein;

FIG. 9 an example results viewing pane in accordance with various aspects described herein;

FIG. 10 is a flow diagram showing an exemplary non-limiting implementation for consumer information aggregation and profile generation;

FIG. 11 is a flow diagram showing an exemplary non-limiting implementation for profile generation;

FIG. 12 is a block diagram representing exemplary non-limiting networked environments in which various non-limiting embodiments described herein can be implemented; and

FIG. 13 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

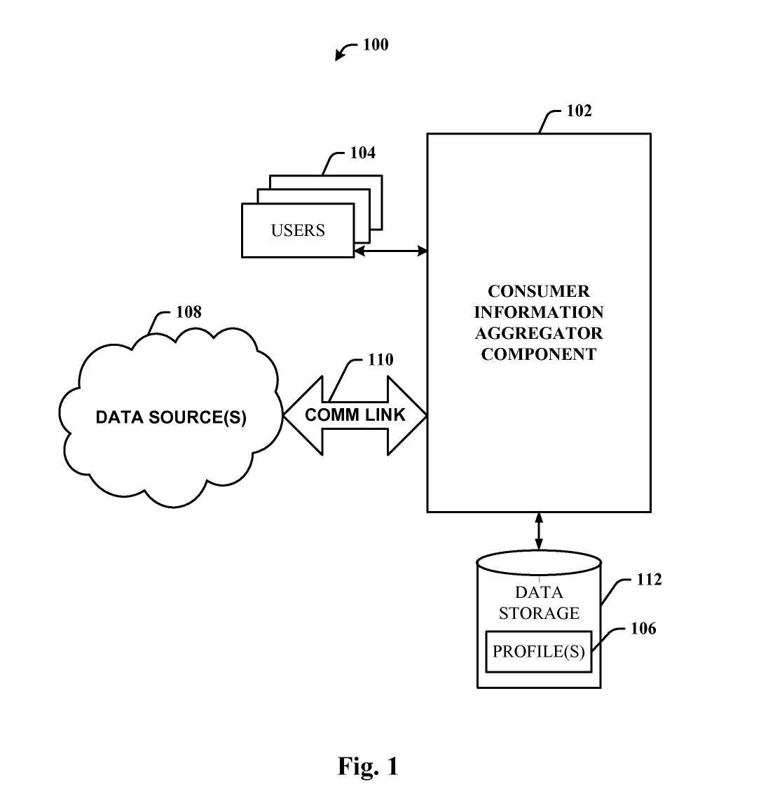

Referring initially to FIG. 1, illustrated is an example consumer information aggregation and profile generation system 100 in accordance with various aspects described herein. The system 100 includes a consumer information aggregator component 102. The consumer information aggregator component 102 (aggregator component 102) can obtain, locate, or otherwise acquire data relating to a user 104, and generate a profile of candidate characteristics 106 (profile 106) based at least in part on the data. In addition, the aggregator component 102 can classify, decide, or otherwise determine an eligibility of the user 104 for one or more offers based at least in part on the profile 106.

The aggregator component 102 obtains, acquires, or otherwise receives one or more identifiers associated with the user. For example, the identifiers can include but are not limited to the user's 104 name, date of birth, email address, home address, phone number, and so forth. The aggregator component 102 can acquire data relating to the user 104 by searching a set of data sources 108 using the identifiers, and collecting a set of search results. The data sources 108 can include virtually any open source or publicly available sources of information, including but not limited to websites, search engine results, social networking websites, online resume databases, job boards, government records, online groups, payment processing services, online subscriptions, and so forth. In addition, the data sources 108 can include private databases, such as credit reports, loan applications, and so forth. The aggregator component 102 can connect to the data sources 108 via a communication link 110 (e.g., comm link, network connection, etc). For example, the aggregator component 102 can obtain a set of data relating to the user 104 by querying one or more internet search engines based on the identifiers.

The aggregator component 102 inspects information included in the set of search results, and generates the profile 106 for the user 104 based at least in part on the information. Continuing with the previous example, the aggregator component 102 can determine a set of information in the search results is relevant for determining offer eligibility, and can include the set of information in the profile 106. The aggregator component 102 can determine the user's 104 offer eligibility based on the profile 106 satisfying a set of predetermined criteria. For instance, if the profile 106 satisfies a predetermined set of loan criteria, then the aggregator component 102 can determine that the user 104 is eligible for one or more loans. It is to be appreciated that although the profile 106 is illustrated as being stored in a data store 112, such implementation is not so limited. For instance, the profile 106 can be associated with an online shopping portal, stored in a cloud based storage system, or the data storage 112 can be included in the aggregator component 102 or a data source 108. In addition, it is to be appreciated that although the aggregator component 102 is illustrated as a stand-alone component, such implementation is not so limited. For instance, the aggregator component 102 can be associated with or included in a software application, an online shopping portal, and so forth.

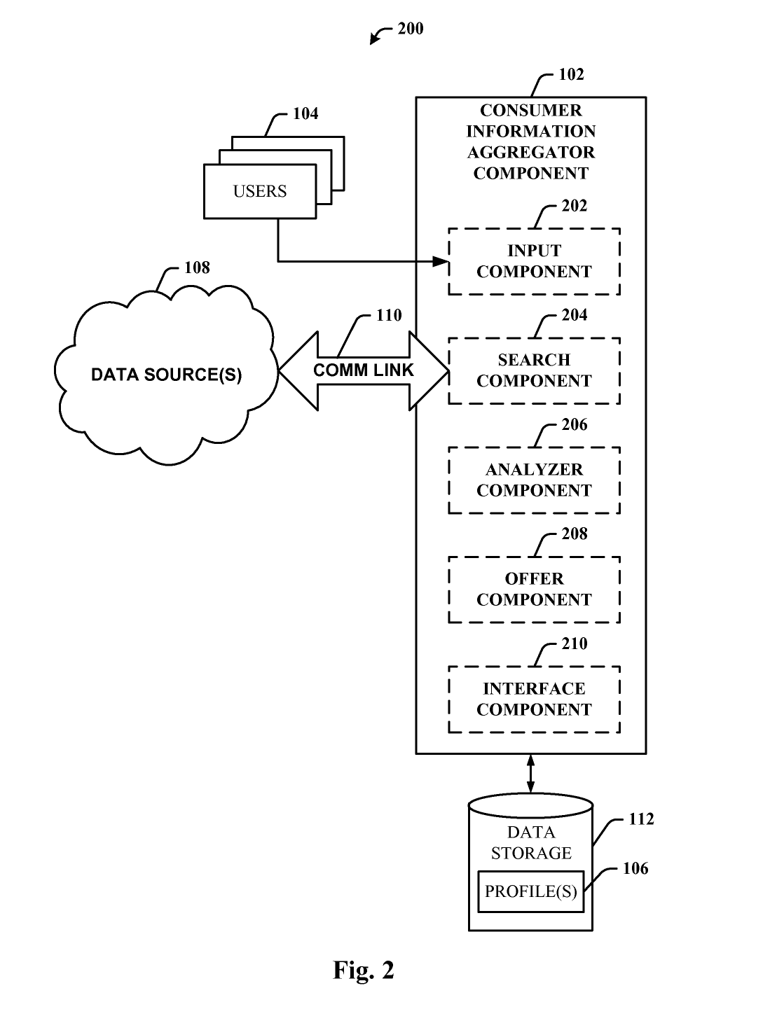

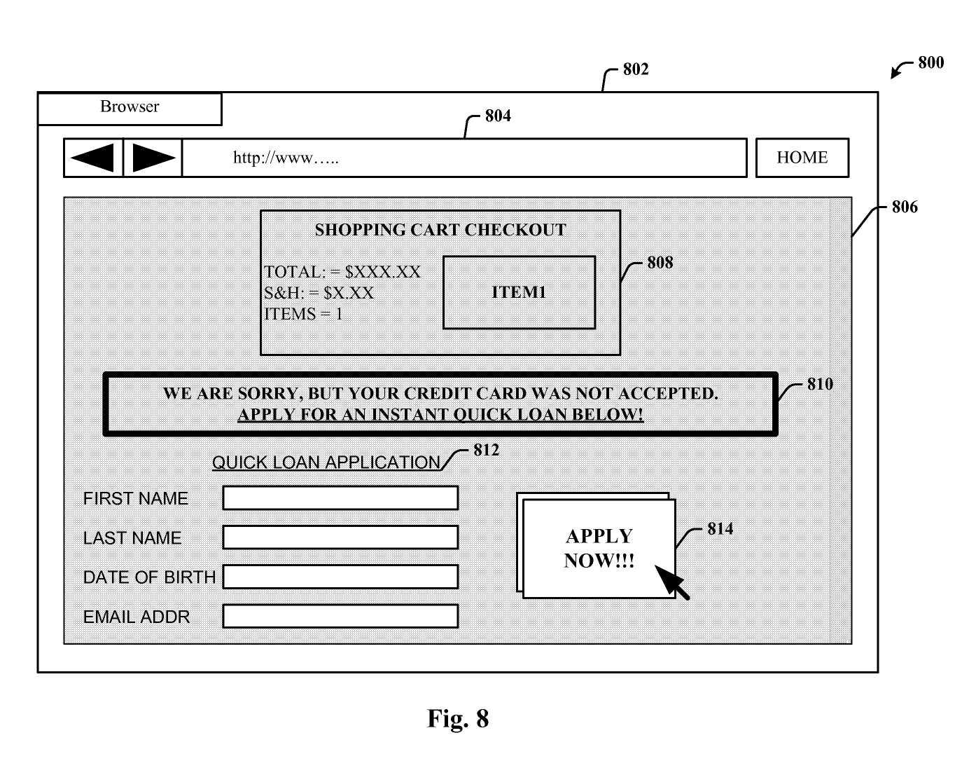

FIG. 2 illustrates an example consumer information aggregation and profile generation system 200 in accordance with various aspects described herein. As discussed previously, the aggregator component 102 can acquire data relating to a user 104, generate a profile 106 based at least in part on the data, and determine an eligibility of the user 104 for one or more offers based at least in part on the profile 106. The aggregator component 102 can include an input component 202, a search component 204, an analyzer component 206, an offer component 208, and an interface component 210. The input component 202 can obtain, acquire, or otherwise receive one or more identifiers associated with the user. For example, the aggregator component 102 can execute via a software application (discussed in greater detail with reference to FIG. 8), wherein the input component 202 can generate one or more user interfaces enabling the user 104 to input the identifiers. Additionally or alternatively, the identifiers can be input by a disparate user, such as a customer service representative, an agent, etc., or the identifiers can be dynamically obtained from a source, such as the data storage 112 or the data sources 108.

The search component 204 can generate, provide, or otherwise determine a set of search terms (e.g., keywords, query terms, etc.) as a function of the identifiers. In addition, the search component 204 can identify, ascertain, or otherwise determine a set of data sources 108 to search based on the search terms or identifiers. For example, the identifiers can include a set of demographic information (e.g., age, location, etc.) for the user 104, and the search component 204 can determine to search a set of websites frequented by users having similar demographic information, or a set of search engines having a high probability of locating information relating to users having similar demographic information. In addition, the search component 204 can perform, direct, or otherwise execute a search on the determined set of data sources 108, and obtain a set of search results for the identifiers. Continuing with the previous example, if the search component 204 determines that information relating to users having similar demographic information can be found via a first and second search engine, then the search component 204 can query the first and second search engine using the search terms.

The analyzer component 206 can examine, inspect, or otherwise analyze the set of search results returned by the search component 204, and determine a subset of search results that are appropriate for inclusion in the profile 106 associated with the user 104. The analyzer component 206 can determine that the subset of search results are relevant for inclusion in the profile 106 based on a correlation with a set of predetermined characteristics, or satisfaction of a set of predetermined criteria. For example, the set of predetermined criterion can include, but are not limited to, a relation of a search result to the user 104, a trustworthiness of the source from which the search result was obtained, or a classification of the result. For example, if the search component 204 returns a social networking website profile for a user having the same name as the user 104, but the profile information (e.g., data birth, email address, etc.) is different from the identifiers known for the user 104, then the analyzer component 206 can determine that the social networking website profile, or information included in the social networking website profile, should not be included in the profile 106.

The offer component 208 can examine, inspect or otherwise analyze the profile 106, and determine the user's 104 eligibility for one or more offers based on whether the profile 106 fulfills, meets, or otherwise satisfies a set of criterion. In addition, the offer component 208 can generate, provide, or otherwise determine a set of terms for the offer. For example, if the offer component 208 determines that the user 104 is eligible for a loan, then the offer component 208 can determine a set of terms for the loan (e.g., interest rate, amount, term, etc.). Continuing with an earlier example, if the aggregator component 102 is accessed via a software application, then the offer component 208 can generate one or more user interfaces based on the user's 104 offer eligibility. For instance, if the offer component 208 determines that the user 104 is eligible for a short term loan, then the offer component 208 can generate a user interface that informs the user 104 of the terms of the loan, and enables the user 104 to accept the loan. Additionally or alternatively, the offer component 208 can expose one or more user interfaces that instruct a customer service representative of the user's 104 offer eligibility.

The interface component 210 includes any suitable and/or necessary adapters, connectors, channels, communication paths, etc. to integrate the system 200 into virtually any operating and/or database system(s). Moreover, the interface component 210 can provide various adapters, connectors, channels, communication paths, etc., that provide for interaction with the system 200. It is to be appreciated that although the interface component 210 is illustrated as incorporated into the aggregator component 102, such implementation is not so limited. For instance, the interface component 210 can be a stand-alone component to receive or transmit data in relation to the system 200.

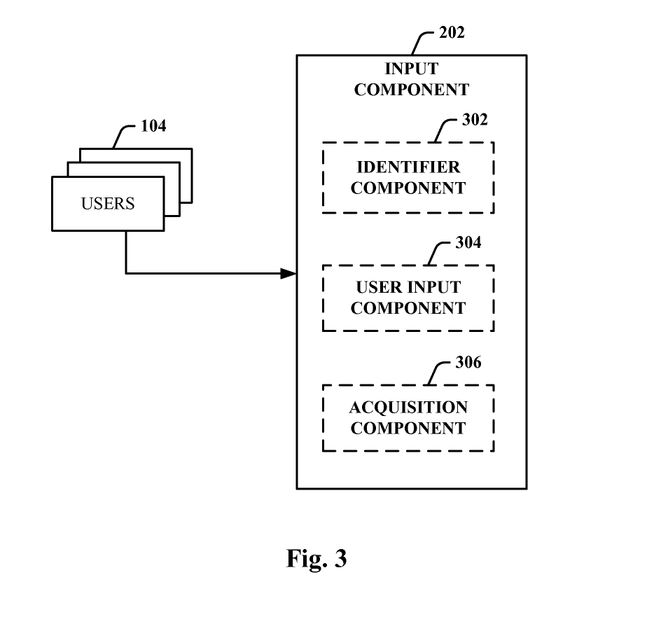

FIG. 3 illustrates an example input component 202 in accordance with various aspects described herein. As discussed previously, the input component 202 can obtain, locate, or otherwise acquire one or more identifiers (e.g., user details, user information, etc.) associated with the user 104, wherein the identifiers can be used to locate information relating to the user 104 to determine the user's 104 eligibility for one or more offers (offer eligibility). The input component 202 can include an identifier component 302, a user input component 304, and an acquisition component 306.

The identifier component 302 can determine a set of identifiers for the user 104 to receive, locate, or otherwise acquire in order to determine the user's 104 eligibility for the one or more offers. The set of identifiers to be acquired can be based on the offer eligibility to be determined. For example, the set of identifiers to determine the user's 104 eligibility for a loan can include a set of predetermined loan application fields (e.g., name, date of birth, email address, etc.). As an additional example, the identifier component 302 can determine that the name of the user 104 is already known based on prior dealings with the user 104, and the set of identifiers can include the identifiers that are not already known (e.g., date of birth, email address, etc.).

The user input component 304 can enable the user 104, or a disparate user (e.g., customer service representative, agent, etc.) to input the set of identifiers determined by the identifier component 302. The identifiers can be input via explicit user inputs (e.g., configuration selections, question/answer) such as from mouse selections, keyboard selections, speech, and so forth. Additionally, the acquisition component 306 can obtain the identifiers via data uploads, wherein a data upload is the transfer of data from the user 104 or a third party source (e.g. computer or a computer readable medium), to the input component 202. For example, the identifiers can be uploaded from the data store 112, data sources 108, a credit or debit card, an identification card, a mobile device (e.g., mobile phone, smart phone, laptop, portable music player, net book, etc.), or a computer.

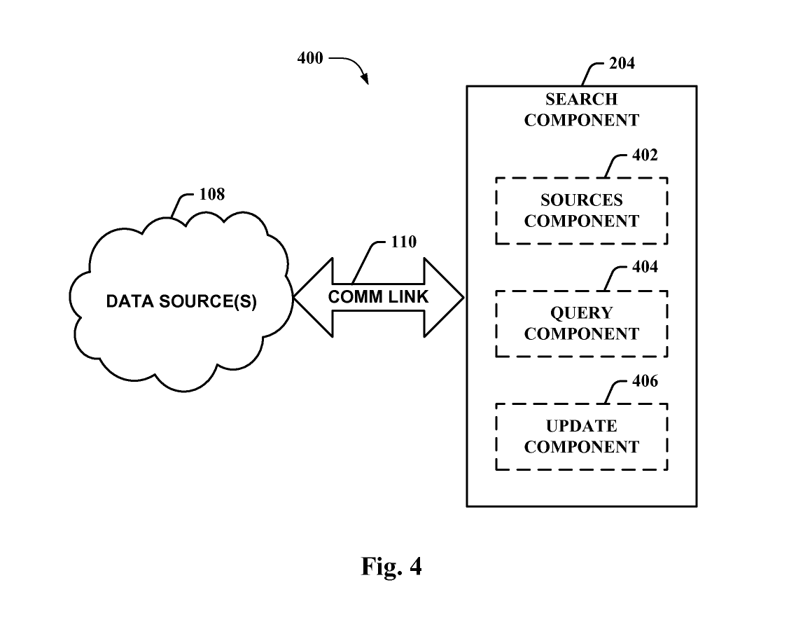

FIG. 4 illustrates an example search component 204 in accordance with various aspects described herein. As discussed previously, the search component 204 can determine a set of data sources 108 to search, execute a search on the determined set of data sources 108, and obtain a set of search results. The search component 204 can include a sources component 402, a query component 404, and an update component 406. The sources component 402 can determine the set of data sources 108 to search for information relating to the user 104 based at least in part on a set of criterion, including but not limited to information associated with the identifiers, a set of possible offers, a set of predetermined search results desired to determine offer eligibility, and so forth. For example, if the set of possible offers includes a loan, then the sources component 402 can determine a first set of data sources to search, and if the set of possible offers includes an alternative purchase option, then the sources component 402 can determine a second set of data sources to search.

The query component 404 can determine a set of keywords (e.g., search terms, query terms, etc.), and execute a search against the determined set of data sources 108 using the set of keywords. The keywords can be based at least in part on the set of identifiers. For example, the query component 404 can execute the search against a set of social networking sites using the user's 104 name, date of birth, email address, and so forth. Additionally or alternatively, the keywords can be based on additional information related to the user 104. Continuing with the previous example, the user 104 can have a username (e.g., screen name, etc.), an alternate email address, and so forth for a service (e.g., shopping portal, etc.) associated with the aggregator component 102, and the query component can use the additional information to search the social networking sites. The query component 404 returns a set of search results.

The update component 406 can modify, alter, or otherwise update the set of keywords, or the set of data sources 108 based at least in part on the set of search results returned by the query component 404. For example, the query component 404 can return search results containing an alias employed by the user 104, and the update component 406 can include the alias in the set of keywords. As an additional example, the update component 406 can update the set of sources 108 based on information, such as an additional email address returned by the query component 404 for the user 104. For instance, if the query component 404 locates an internet email address associated with the user 104, wherein the internet email is hosted by a first social networking site (e.g., user@1stsocialnetwork.com), then the update component 406 can include the first social networking site in the set of sources 108.

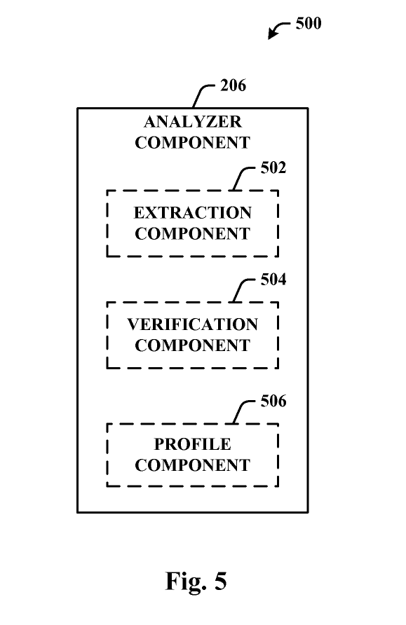

Turning now to FIG. 5, illustrated is an example analyzer component 206 in accordance with various aspects described herein. As discussed previously, the analyzer component 206 can examine the set of search results returned by the search component 204, and determine a subset of the search results that are appropriate for inclusion in the profile 106 associated with the user 104. The analyzer component 206 includes an extraction component 502, a verification component 504, and a profile component 506. The extraction component 502 can inspect the set of search results returned by the search component 204, and identify, ascertain, or otherwise determine data included in the set of search results that is pertinent to determining offer eligibility. The extraction component 502 can determine data that is pertinent to determining offer eligibility based at least in part on a set of offer criterion. For example, the set of offer criterion for a short term loan can include a predetermined set of characteristics, such as age, gender, profession, income, residence, education, debt, and so forth, and the extraction component 502 can determine data included in the set of search results (e.g., a subset of the set of search results) that correlates to the set of characteristics.

The verification component 504 can confirm, validate, or otherwise verify that the data included in the set of search results is associated with the user 104. The verification component 504 can compare the data to other known information, or additional search results, and generate a confidence score for the data based at least in part on the comparison. If the confidence score is within a predetermined confidence threshold, then the verification component 504 can verify that the data is associated with the user. Additionally or alternatively, the verification component 504 can generate the confidence score based at least in part on whether the data satisfies a set of verification criterion. For example, the verification component 504 can compare the data to the identifiers, and if the data satisfies the set of verification criterion, such as, originating from a trusted source, then the verification component 504 can weight the confidence score accordingly.

The profile component 506 can update, generate, or otherwise include verified data in the profile 106. For example, the profile 106 for the user 104 may have been previously established with a service associated with the aggregator component 102, and the profile component 506 can update the profile 106 based on the verified data. For instance, the aggregator component 102 can be associated with an online shopping portal, wherein the user 104 has previously setup an account (e.g., profile) with the shopping portal, and the profile component 506 can update the account based on the verified data. Additionally or alternatively, the profile component 506 can generate the profile 106 for the user 104 based on the verified data. For instance, if the user 104 has not transacted with the shopping portal prior to the offer eligibility determination, then the profile component 506 can create the profile 106 based at least in part on the verified data.

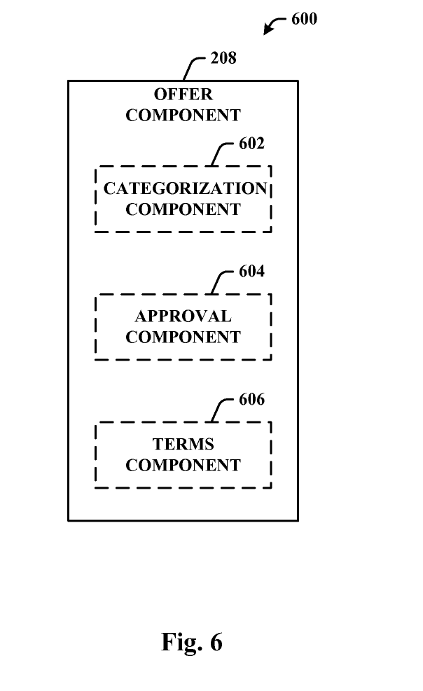

FIG. 6 illustrates an example offer component 208 in accordance with various aspects described herein. As discussed previously, the offer component 208 can analyze the profile 106, and determine eligibility for one or more offers based on whether the profile 106 satisfies a set of offer criterion. The offer component 208 includes a categorization component 602, an approval component 604, and a terms component 606. The categorization component 602 can examine the profile 106, and classify, grade, or otherwise categorize the profile 106 based at least in part on a set of categorization criterion. For example, the categorization component 602 can examine the profile 106, and classify the profile 106 based on a set of loan criterion, such as income, residence, profession, and so forth. The categorization component 602 can classify the profile 106 by assigning a ranking, a grade, a numerical score, or virtually any indicator to the profile 106. The indicators can be used to identify the user's risk of repaying a loan, ability to repay a loan, loyalty to a service associated with the aggregator component 102, and so forth. As an additional example, the categorization component 602 can classify the profile 106 based on the set of categorization criterion. For example, if the offer component 602 is determining the user's 104 eligibility for a short term loan (e.g. offer), then the categorization component 602 can apply a classification to the profile 106, such as, high risk, average risk, or low risk.

The approval component 604 can determine whether the user 104 is eligible for one or more offers based at least in part on the categorization generated by the categorization component 602. Continuing with the previous example, if the categorization component 602 classifies the profile 106 as low risk, then the approval component 604 can determine that the user is eligible for the short term loan. Additionally or alternatively, the approval component 604 can determine whether the user 104 is eligible for one or more offers based at least in part on a set of additional criterion. For example, the additional criterion can include the confidence score generated by the verification component 504, promotions relating to the one or more offers (e.g., sales, etc.), and so forth. Returning again to the previous example, if the profile is classified as high risk, then the approval component 604 can determine that the user 104 is not eligible for the short term loan. However, if a service associated with the aggregator component 102 is currently conducting a high-risk financing promotion, then the approval component 604 can determine that the user 104 is eligible for short term loan.

Where the user 104 is eligible for an offer, the terms component 606 can select, acquire, or otherwise determine a set of terms for the offer. The terms component 606 can select the set of terms from a set of predetermined terms, or the terms component 606 can dynamically generate the set of terms. Continuing with the previous example, the terms component 606 can determine a first set of terms (e.g., max amount, interest rate, period, etc.) if the user is classified as low risk, a second set of terms if the user 104 is classified as average risk, and a third set of terms if the user is classified as high risk.

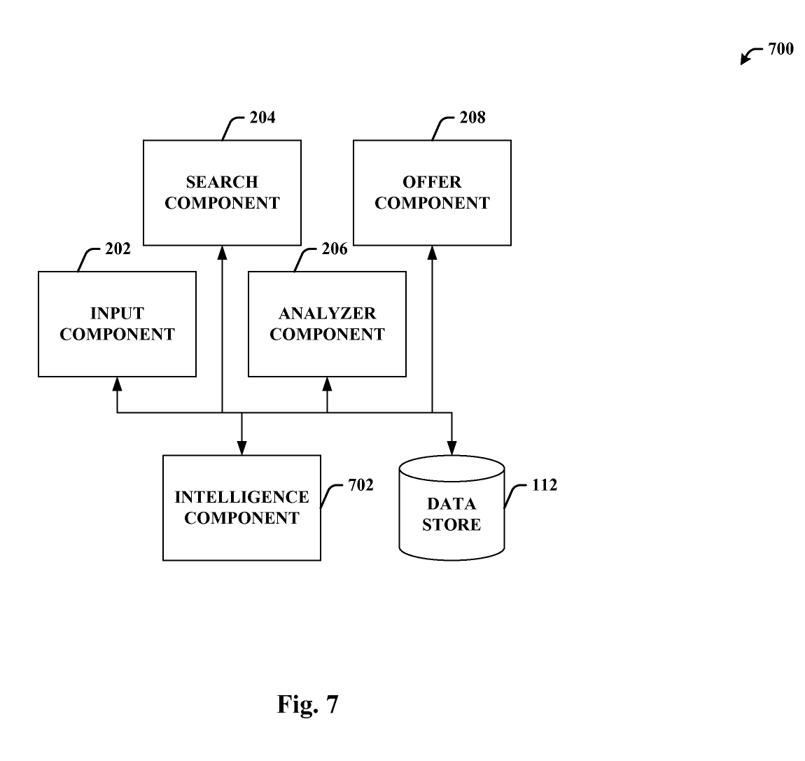

Referring now to FIG. 7, system 700 that can provide for or aid with various inferences or intelligent determinations is depicted. Generally, system 700 can include all or a portion of the input component 202, the search component 204, the analyzer component 206, and the offer component 208 as substantially described herein. In addition to what has been described, the above-mentioned components can make intelligent determinations or inferences. For example, input component 202 can intelligently determine or infer a set of identifiers.

Likewise, the search component 204 can also employ intelligent determinations or inferences in connection with determining a set of sources, or determining a set of keywords. In addition, the analyzer component 206 can intelligently determine or infer data included in the search results, and perform verification of the data. Additionally, the offer component 208 intelligently determine or infer categorization of the profile 106, approval for one or more offers, or a set of terms for the offers. Any of the foregoing inferences can potentially be based upon, e.g., Bayesian probabilities or confidence measures or based upon machine learning techniques related to historical analysis, feedback, and/or other determinations or inferences.

In addition, system 700 can also include an intelligence component 702 that can provide for or aid in various inferences or determinations. In particular, in accordance with or in addition to what has been described supra with respect to intelligent determination or inferences provided by various components described herein. For example, all or portions of the input component 202, the search component 204, the analyzer component 206, and the offer component 208 (as well as other components described herein) can be operatively coupled to intelligence component 702. Additionally or alternatively, all or portions of intelligence component 702 can be included in one or more components described herein. Moreover, intelligence component 702 will typically have access to all or portions of data sets described herein, such as in the data storage 112.

Accordingly, in order to provide for or aid in the numerous inferences described herein, intelligence component 702 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

Turning to FIG. 8, illustrated is an example identifier input viewing pane 800 in accordance with various aspects described herein. As discussed previously, the aggregator component 800 can be associated with an internet shopping portal. The shopping portal can be accessed via a web browser 802 that includes an address bar 804 (e.g., URL bar, location bar, etc.). The web browser 802 can expose a checkout screen 806 that includes a shopping cart checkout section 808. The shopping cart checkout section 808 can include a set of items (e.g., item1) that a user (e.g., user 104) has selected, added to the shopping cart, or otherwise intends to purchase. The shopping cart checkout section 808 can include additional information related to the transaction, such as, a total purchase price, a number of items in the shopping cart, a shipping and handling charge for the items, and so forth.

The checkout screen 806 can further include an offer message 810. For example, the user may have attempted to purchase the items displayed in the shopping cart checkout section 808, but the transaction may have failed to complete for any of a plurality of reasons. For example, the user's credit card may have been declined, because they exceeded their maximum balance, or the user may have insufficient funds in an account associated with the credit card. The offer message section 810 can inform the user of the failed transaction, and can inform the user of an opportunity to apply for one or more offers (e.g., Instant Quick Loan).

An input section 812 (e.g., application) can contain a set of fields to be provided for the user to apply for the offer. As discussed previously, the input component 202 can determine a set of identifiers to receive in order to determine eligibility for one or more offers. The set of fields included in the input section 810 can be generated by the input component 202, or can correspond to the set of identifiers determined by the input component 202. Additionally or alternatively, the aggregator component 102 can dynamically determine to offer a pre-approved offer to the user 102 based on a set of pre-approval factors without requiring the user 104 to apply for the offer via the identifier viewing pane 800 (e.g., input section 812). For example, the pre-approval factors can include membership in a predetermined set of pre-approved users. In addition, offers made to the user 104 can be targeted based on the set of pre-approval factors. Additionally, the checkout screen 806 can include a completion button 812 (e.g., “apply now button”) that will initiate an offer eligibility determination. As discussed previously, the aggregator component 102 can determine and search a set of sources (e.g., search component 203) for information relating to the user, analyze the search results (e.g., analyzer component 206), and determine if the user is eligible (e.g., offer component 208) for the offer (e.g., “Instant Quick Loan”).

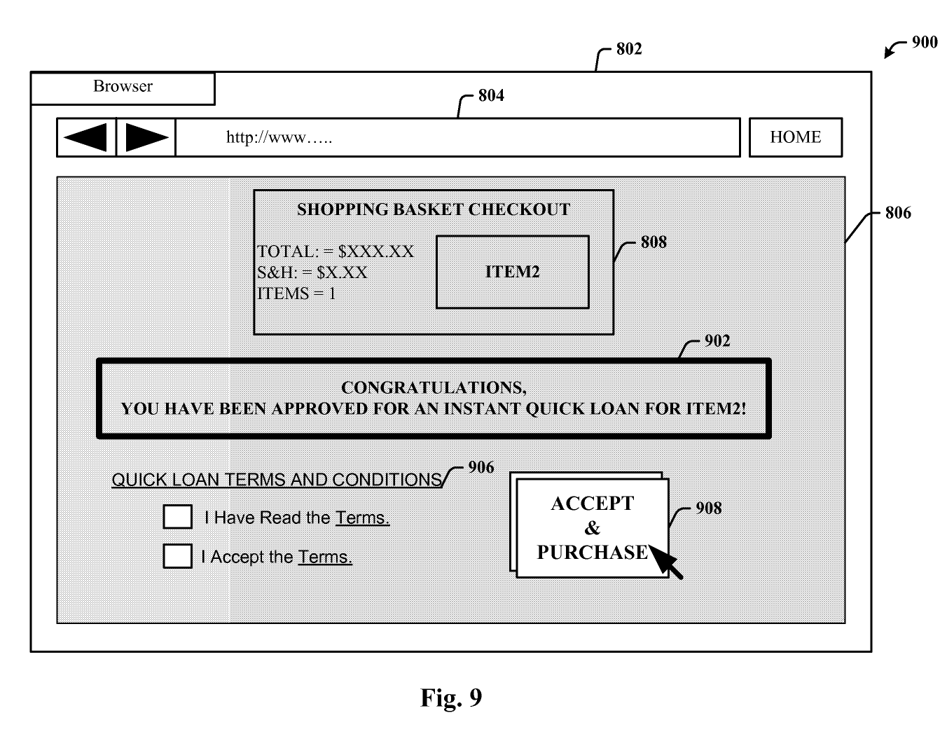

FIG. 9 illustrates an example results viewing pane 900 in accordance with various aspects described herein. The results viewing pane 900 can expose the results of the offer eligibility determination, as discussed supra. The results viewing pane 900 can include an offer eligibility determination section 902. The offer eligibility determination section 902 can expose a result of the offer eligibility determination. For example, the offer eligibility determination section 902 can detail that the user is eligible for the offer applied for which they applied (See FIG. 8), or whether the user's application for the offer has been declined. Additionally, the offer eligibility determination section 902 can detail an additional offer for which the user is eligible. For instance, the user can apply for a first offer, and it can be determined (e.g., via the offer component 208) that the user is eligible for a second offer in addition to, or in place of, the first offer. For example the user may have applied for a quick loan for item1, and it can be determined that the user is not eligible for the quick loan for the purchase price of item1, but is eligible for a quick loan for a purchase price of item2, where item2 costs less than item1. As an additional example, it can be determined that the user is eligible for a quick loan for the purchase price of item1 and item2, where item1 and item2 are related items.

A terms and condition section 906 can enable the user to view the terms and conditions of any offers for which they are determined to be eligible. As discussed previously, the offer component 208 can determine a set of terms for the offer, or offers, based on the identifiers, profile 106, a confidence score associated with the profile, a categorization of the profile, a set of additional information, and so forth. In addition, the terms and conditions section 906 can include one or more fields that require the user to acknowledge that they have read the terms and conditions, accept the terms and conditions, and so forth. An offer acceptance button 908 enables the user to accept the offer and the terms and conditions associated with the offer. For example, the user can complete the checkout process by selecting the offer acceptance button 908.

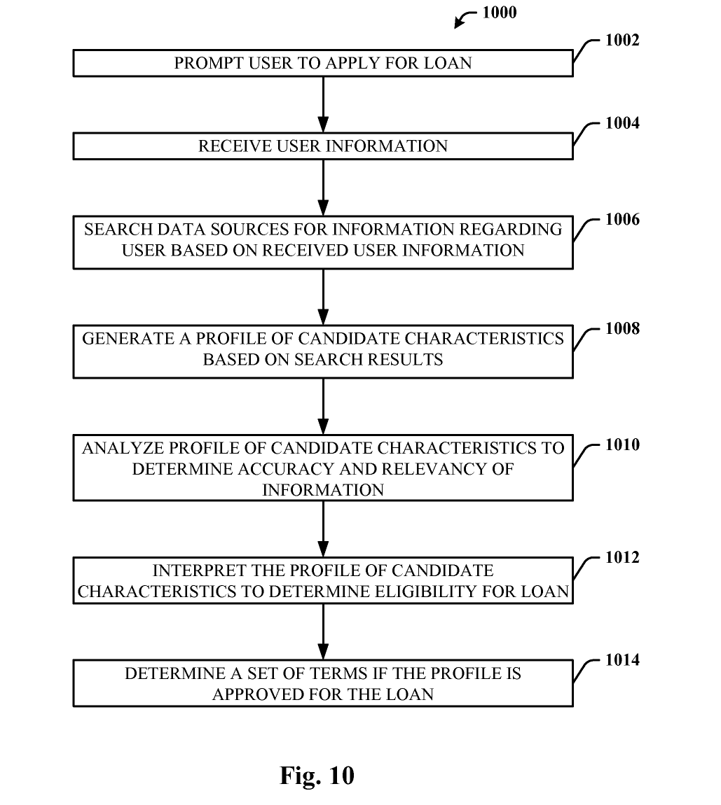

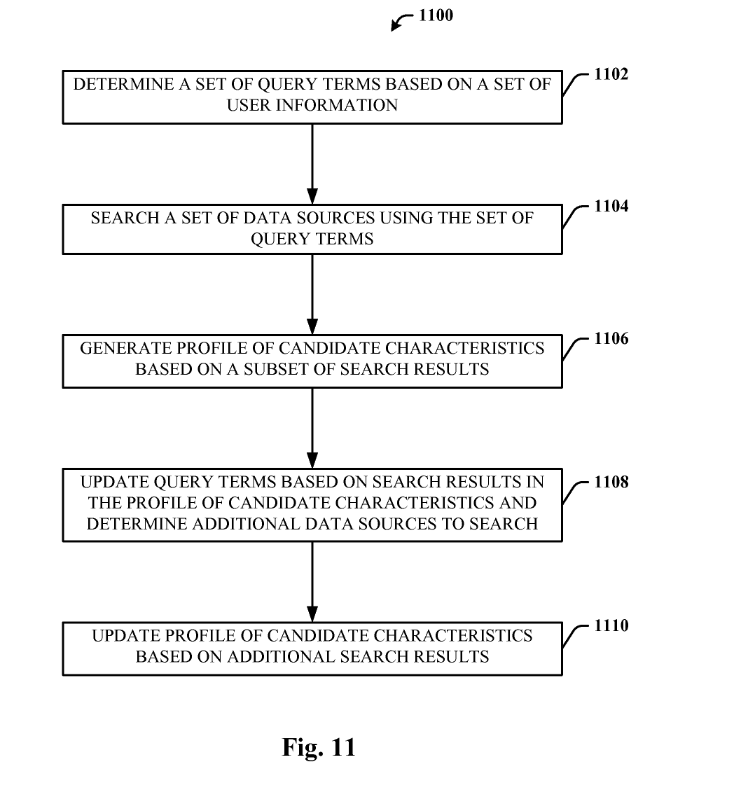

In view of the example systems described supra, methods that may be implemented in accordance with the described subject matter may be better appreciated with reference to the flow charts of FIGS. 10-11. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 10, illustrated is an example methodology for consumer information aggregation and profile generation 1000 in accordance with aspects described herein. Methodology 1000 can begin at block 1002, wherein a user is promoted to apply for one or more offers, such as a loan. For example, the user's credit card may have been declined during a checkout process at an internet shopping portal, and the shopping portal can offer the user an opportunity to apply for a loan (e.g., offer eligibility determination) for the intended purchase. At 1004, a set of user information (e.g., identifiers, application fields, etc.) can be received. For example, the set of user information can include a first name, a last name, a date of birth, and an email address. As discussed previously, the user information desired to for the offer eligibility determination can be received from the user, a disparate user (e.g., customer service representative, agent, etc.), obtained from a data store, or an associated profile. Additionally or alternatively, as discussed previously, an offer eligibility determination can be dynamically made based on a set of pre-approval factors without requiring receipt of the user information. For example, the pre-approval factors can include membership in a predetermined set of pre-approved users. In addition, offers made to the user can be targeted based on the set of pre-approval factors.

At 1006, a set of data sources can be searched for information regarding the user based on the user information received at 1004. The data sources can include virtually any open source or publicly available sources of information, including but not limited to websites, search engine results, social networking websites, online resume databases, job boards, government records, online groups, payment processing services, online subscriptions, and so forth. In addition, the data sources can include private databases, such as credit reports, loan applications, and so forth. At 1008, a profile of candidate characteristics (profile) can be generated based on the search results. The profile of candidate characteristics can include data from the search results that corresponds, correlates, or otherwise matches a set of predetermined characteristics for determining offer eligibility.

At 1010, the profile is analyzed to determine the accuracy of the information included in the profile, and the relevancy of the information to the offer eligibility determination. The accuracy is determined by comparing the information to other known information, or additional search results, and generating a confidence score for the information based at least in part on the comparison. If the confidence score is within a predetermined confidence threshold, then the information is determined accurate. Additionally or alternatively, the confidence score can be generated based at least in part on whether the data satisfies a set of verification criterion. The relevancy of the information to the offer eligibility determination is determined based at least in part on a set of offer criterion. For example, the set of offer criterion for a loan can include a set of predetermined characteristics, such as age, gender, profession, income, residence, education, debt, and so forth, and if the data information included in the profile correlates to the criterion, then it is relevant.

At 1012, the profile is interpreted to determine eligibility for the offer. The profile is classified, graded, or otherwise categorized based at least in part on a set of categorization criterion. For example, the profile can be classified based on a set of loan criterion, such as income, residence, profession, and so forth. The profile can be classified by assigning a ranking, a grade, a numerical score, or virtually any indicator to the profile. The indicators can be used to identify the user's risk of repaying a loan, ability to repay a loan, loyalty, and so forth. As an additional example, the profile can be classified based on the set of categorization criterion. For example, if the offer is for a loan, then the profile can be classified based on a set of predetermined loan classification, such as, high risk, average risk, or low risk. Eligibility for the offer is based at least in part on the classification. Continuing with the previous example, if the profile is classified as low risk, then it can be determined that the user is eligible for the loan. Additionally or alternatively, eligibility can be based on a set of additional criterion. For example, the additional criterion can include the confidence score, promotions relating to the one or more offers (e.g., sales, etc.), and so forth. Additionally, a determination can be made whether the user is eligible for one or more additional offers. For instance, the user can apply for a first offer, and it can be determined (e.g., via the offer component 208) that the user is eligible for a second offer in addition to, or in place of, the first offer. For example the user may have applied for a loan for a first item, and it can be determined that the user is not eligible for a loan for the purchase price of the first item, but is eligible for a loan for a purchase price of a second item, where the second item costs less than the first item. As an additional example, it can be determined that the user is eligible for a loan for the purchase price of the first item and the second item, where the first and second items are related.

Where the user is eligible for an offer, a set of terms for the offer are determined, at 1014. The set of terms can be selected from a set of predetermined terms, or dynamically generated. Continuing with the previous example, a first set of terms (e.g., max amount, interest rate, period, etc.) can be determined if the user is classified as low risk, a second set of terms can be determined if the user is classified as average risk, and a third set of terms can be determined if the user is classified as high risk.

Referring to FIG. 11, illustrated is an example methodology for consumer information scanning 1100 in accordance with aspects described herein. Methodology 1100 can begin at block 1102, wherein a set of query terms (e.g., keywords, search terms, etc.) are determined based on a set of user information. The user information can be received from the user, received from a disparate user (e.g., customer service representative, agent, etc.), obtained from a profile associated with the user, acquired from one or more data sources, or included in known information relating to the user.

At 1104, a set of data sources are searched using the set of query terms. The set of data sources can be selected based at least in part on the query terms or user information, and can include virtually any open source or publicly available sources of information, or private databases. At 1106, a profile of candidate characteristics (profile) is generated based on a subset of search results. The subset of search results can include search results containing information correlating to one or more characteristics in a set of predetermined characteristics. For example, the set of predetermined characteristics for a loan can include occupation, salary, residence, marital status, and so forth.

At 1108, the query terms are updated based on search results in the profile, and additional data sources to be search are determined. For example, the search results can include a possible alias employed by the user, and the query terms can be updated based on the alias. At 1110, the profile is updated based on the additional search results. Continuing with the previous example, search results for the possible alias may include a place of employment, and the profile can be updated to include the place of employment.

### Exemplary Networked and Distributed Environments

One of ordinary skill in the art can appreciate that the various non-limiting embodiments of the shared shopping systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

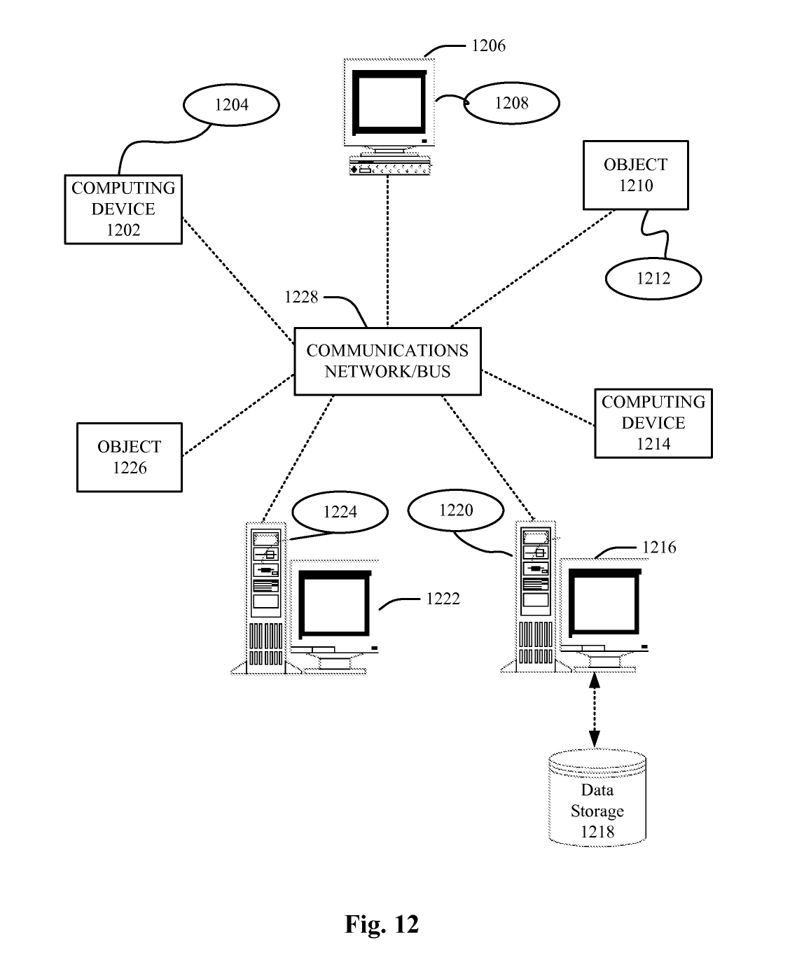

FIG. 12 provides a schematic diagram of an exemplary networked or distributed computing environment. The distributed computing environment comprises computing objects 1210, 1212, etc. and computing objects or devices 1220, 1222, 1224, 1226, 1228, etc., which may include programs, methods, data stores, programmable logic, etc., as represented by applications 1230, 1232, 1234, 1236, 1238. It can be appreciated that computing objects 1210, 1212, etc. and computing objects or devices 1220, 1222, 1224, 1226, 1228, etc. may comprise different devices, such as personal digital assistants (PDAs), audio/video devices, mobile phones, MP3 players, personal computers, laptops, etc.

Each computing object 1210, 1212, etc. and computing objects or devices 1220, 1222, 1224, 1226, 1228, etc. can communicate with one or more other computing objects 1210, 1212, etc. and computing objects or devices 1220, 1222, 1224, 1226, 1228, etc. by way of the communications network 1240, either directly or indirectly. Even though illustrated as a single element in FIG. 12, communications network 1240 may comprise other computing objects and computing devices that provide services to the system of FIG. 12, and/or may represent multiple interconnected networks, which are not shown. Each computing object 1210, 1212, etc. or computing object or device 1220, 1222, 1224, 1226, 1228, etc. can also contain an application, such as applications 1230, 1232, 1234, 1236, 1238, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 12, as a non-limiting example, computing objects or devices 1220, 1222, 1224, 1226, 1228, etc. can be thought of as clients and computing objects 1210, 1212, etc. can be thought of as servers where computing objects 1210, 1212, etc., acting as servers provide data services, such as receiving data from client computing objects or devices 1220, 1222, 1224, 1226, 1228, etc., storing of data, processing of data, transmitting data to client computing objects or devices 1220, 1222, 1224, 1226, 1228, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1240 or bus is the Internet, for example, the computing objects 1210, 1212, etc. can be Web servers with which other computing objects or devices 1220, 1222, 1224, 1226, 1228, etc. communicate via any of a number of known protocols, such as the hypertext transfer protocol (HTTP). Computing objects 1210, 1212, etc. acting as servers may also serve as clients, e.g., computing objects or devices 1220, 1222, 1224, 1226, 1228, etc., as may be characteristic of a distributed computing environment.

### Exemplary Computing Device

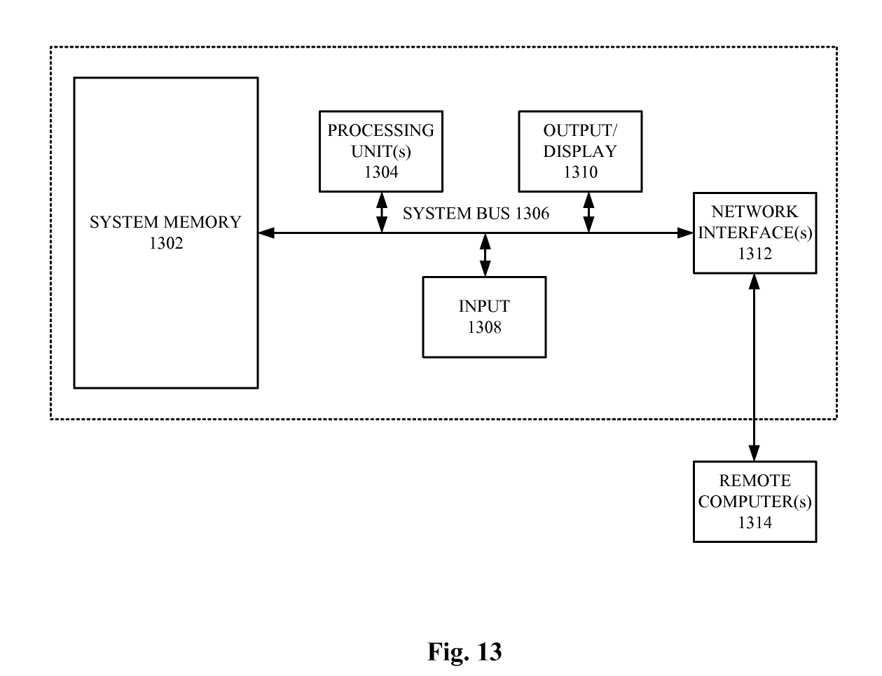

As mentioned, advantageously, the techniques described herein can be applied to any device where it is desirable to facilitate shared shopping. It is to be understood, therefore, that handheld, portable and other computing devices and computing objects of all kinds are contemplated for use in connection with the various non-limiting embodiments, i.e., anywhere that a device may wish to engage in a shopping experience on behalf of a user or set of users. Accordingly, the below general purpose remote computer described below in FIG. 13 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 13 thus illustrates an example of a suitable computing system environment 1300 in which one or aspects of the non-limiting embodiments described herein can be implemented, although as made clear above, the computing system environment 1300 is only one example of a suitable computing environment and is not intended to suggest any limitation as to scope of use or functionality. Neither should the computing system environment 1300 be interpreted as having any dependency or requirement relating to any one or combination of components illustrated in the exemplary computing system environment 1300.

With reference to FIG. 13, an exemplary remote device for implementing one or more non-limiting embodiments includes a general purpose computing device in the form of a computer 1310. Components of computer 1310 may include, but are not limited to, a processing unit 1320, a system memory 1330, and a system bus 1322 that couples various system components including the system memory to the processing unit 1320.

Computer 1310 typically includes a variety of computer readable media and can be any available media that can be accessed by computer 1310. The system memory 1330 may include computer storage media in the form of volatile and/or nonvolatile memory such as read only memory (ROM) and/or random access memory (RAM). Computer readable media can also include, but is not limited to, magnetic storage devices (e.g., hard disk, floppy disk, magnetic strip), optical disks (e.g., compact disk (CD), digital versatile disk (DVD)), smart cards, and/or flash memory devices (e.g., card, stick, key drive). By way of example, and not limitation, system memory 1330 may also include an operating system, application programs, other program modules, and program data.

A user can enter commands and information into the computer 1310 through input devices 1340. A monitor or other type of display device is also connected to the system bus 1322 via an interface, such as output interface 1350. In addition to a monitor, computers can also include other peripheral output devices such as speakers and a printer, which may be connected through output interface 1350.

The computer 1310 may operate in a networked or distributed environment using logical connections to one or more other remote computers, such as remote computer 1370. The remote computer 1370 may be a personal computer, a server, a router, a network PC, a peer device or other common network node, or any other remote media consumption or transmission device, and may include any or all of the elements described above relative to the computer 1310. The logical connections depicted in FIG. 13 include a network 1372, such local area network (LAN) or a wide area network (WAN), but may also include other networks/buses. Such networking environments are commonplace in homes, offices, enterprise-wide computer networks, intranets and the Internet.

As mentioned above, while exemplary non-limiting embodiments have been described in connection with various computing devices and network architectures, the underlying concepts may be applied to any network system and any computing device or system.

Also, there are multiple ways to implement the same or similar functionality, e.g., an appropriate application programming interface (API), tool kit, driver source code, operating system, control, standalone or downloadable software object, etc. which enables applications and services to take advantage of techniques provided herein. Thus, non-limiting embodiments herein are contemplated from the standpoint of an API (or other software object), as well as from a software or hardware object that implements one or more aspects of the shared shopping techniques described herein. Thus, various non-limiting embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various non-limiting embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

As discussed herein, the various embodiments disclosed herein may involve a number of functions to be performed by a computer processor, such as a microprocessor. The microprocessor may be a specialized or dedicated microprocessor that is configured to perform particular tasks according to one or more embodiments, by executing machine-readable software code that defines the particular tasks embodied by one or more embodiments. The microprocessor may also be configured to operate and communicate with other devices such as direct memory access modules, memory storage devices, Internet-related hardware, and other devices that relate to the transmission of data in accordance with one or more embodiments. The software code may be configured using software formats such as Java, C++, XML (Extensible Mark-up Language) and other languages that may be used to define functions that relate to operations of devices required to carry out the functional operations related to one or more embodiments. The code may be written in different forms and styles, many of which are known to those skilled in the art. Different code formats, code configurations, styles and forms of software programs and other means of configuring code to define the operations of a microprocessor will not depart from the spirit and scope of the various embodiments.

Within the different types of devices, such as laptop or desktop computers, hand held devices with processors or processing logic, and also possibly computer servers or other devices that utilize one or more embodiments, there exist different types of memory devices for storing and retrieving information while performing functions according to the various embodiments. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to one or more embodiments when executed, or in response to execution, by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to one or more embodiments as described herein enable the physical transformation of these memory devices. Accordingly, one or more embodiments as described herein are directed to novel and useful systems and methods that, in the various embodiments, are able to transform the memory device into a different state when storing information. The various embodiments are not limited to any particular type of memory device, or any commonly used protocol for storing and retrieving information to and from these memory devices, respectively.

Embodiments of the systems and methods described herein facilitate the management of data input/output operations. Additionally, some embodiments may be used in conjunction with one or more conventional data management systems and methods, or conventional virtualized systems. For example, one embodiment may be used as an improvement of existing data management systems.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Although some specific embodiments have been described and illustrated as part of the disclosure of one or more embodiments herein, such embodiments are not to be limited to the specific forms or arrangements of parts so described and illustrated. The scope of the various embodiments are to be defined by the claims appended hereto and their equivalents.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other. As used herein, unless explicitly or implicitly indicating otherwise, the term “set” is defined as a non-zero set. Thus, for instance, “a set of criteria” or “a set of criterion” can include one criterion, or many criteria.

A number of embodiments have been described. Nevertheless, it will be understood that various modifications may be made without departing from the spirit and scope of the disclosure.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims and their equivalents.

1. A system, comprising:
an input component configured to receive a set of identifiers associated with a user;
a search component configured to generate a set of search terms based at least in part on the set of identifiers, execute a search against a set of data sources using the set of search terms, and return a set of search results;
an analyzer component configured to analyze the set of search results, and at least one of generate or update a profile for the user based at least in part on a subset of the search results; and
an offer component configured to determine eligibility for an offer based at least in part on the profile.

2. The system of claim 1, wherein the offer includes a loan.

3. The system of claim 1, wherein the input component is further configured to obtain a subset of the identifiers from the profile associated with user.

4. The system of claim 1, wherein the search component is further configured to determine the set of data sources based at least in part on at least one of the set of identifiers, or the set of search terms.

5. The system of claim 4, wherein the search component is further configured to update at least one of the set of search terms, or the set of data sources based at least in part on the set of search results.

6. The system of claim 1, wherein the analyzer component is further configured to select the subset of results based on a set of predetermined characteristics for determining eligibility.

7. The system of claim 1, wherein the analyzer component is further configured to determine a confidence score for the subset of results, wherein the confidence score indicates a likelihood that the subset of results are associated with the user.

8. The system of claim 1, wherein the offer component is further configured to analyze the profile, classify the profile based at least in part on the analysis, and determine eligibility for the offer based at least in part on the classification.

9. The system of claim 1, wherein the offer component is further configured to determine eligibility of the user for at least one additional offer based at least in part on the profile.

10. The system of claim 9, wherein the at least one additional offer is at least one of related to the offer, or a replacement for the offer.

11. The system of claim 1, wherein the set of data sources include at least one of a website, a search engine, a social networking site, an online resume database, a job board, a government record, an online group, a payment processing service, or an online subscription.

12. A method, comprising:
receiving a set of user information for a user;
generating a set of query terms based at least in part on the set of user information;
executing a search against a set of data sources using the set of query terms;
returning a set of search results;
determining a set of data included in the set of search results to include in a user profile; and
determining an eligibility of the user for at least one offer based at least in part on the user profile.

13. The method of claim 12, wherein the determining the eligibility of the user for the at least one offer comprises determining eligibility for a loan.

14. The method of claim 12, further comprising determining the set of data sources based at least in part on at least one of the set of user information, or the set of query terms.

15. The method of claim 12, further comprising updating at least one of the set of query terms, or the set of data sources based at least in part on the set of search results.

16. The method of claim 12, wherein the determining the set of data comprises determining the set of data matching a set of predetermined characteristics for determining eligibility.

17. The method of claim 12, further comprising determining a confidence score for the set of data, wherein the confidence score indicates a likelihood that the set of data is associated with the user.

18. The method of claim 12, wherein the determining the eligibility of the user further comprises analyzing the profile, classifying the profile based at least in part on the analysis, and determining eligibility for the offer based at least in part on the classifying.

19. The method of claim 12, wherein the executing the search against the set of data sources comprises executing the search against at least one of a website, a search engine, a social networking site, an online resume database, a job board, a government record, an online group, a payment processing service, or an online subscription.

20. A computer readable storage medium comprising computer executable instructions that, in response to execution by a computing system, cause the computing system to perform operations, comprising:
receiving a set of user information for a user;
determining a set of keywords as a function of the set of user information;
executing a search against a set of data sources for the set of keywords;
selecting a set of search results to include in a profile of candidate characteristics associated with the user; and
determining an eligibility of the user for a loan based at least in part on the profile of candidate characteristics.

21. The computer readable storage medium of claim 20, further comprising determining the set of data sources as a function of at least one of the set of profile of candidate characteristics, or the set of keywords.

22. The computer readable storage medium of claim 20, further comprising updating at least one of the set keywords, or the set of data sources based at least in part on the set of search results.

23. The computer readable storage medium of claim 20, wherein the selecting the set of search results comprises determining the set of set of search results corresponding to a set of predetermined characteristics for determining eligibility.

24. The computer readable storage medium of claim 20, further comprising determining a confidence score for the set of search results, wherein the confidence score indicates a likelihood that the set of search results are associated with the user.

25. The computer readable storage medium of claim 20, wherein the determining the eligibility of the user further comprises analyzing the profile of candidate characteristics, categorizing the profile of candidate characteristics based at least in part on the analysis, and determining eligibility for the offer based at least in part on the categorizing.

26. A system, comprising:
means for receiving a set of identifiers associated with a user;
means for generating a set of keywords based at least in part on the set identifiers;
means for determining a set of data sources to query based at least in part on at least one of the set of identifiers, or the set of keywords;
means for executing a search against the set of data sources using the keywords, and returning a set of search results;
means for ascertaining a set of characteristics associated with the user based at least in part on the set of search results, and generating a profile based on the set of characteristics; and
means for analyzing the profile, categorizing the profile based at least in part on the analysis, and determining an eligibility of the user for a loan based at least in part on the categorizing.

27. The system of claim 26, further comprising means for determining a set of terms for the loan based at least in part on at least one of the categorizing the profile.
